(19) United States
(12) Patent Application Publication
(10) Pub. No.: US 2025/0193804 A1
(43) Pub. Date: Jun. 12, 2025

(54) Method for allocating MCS and Resource Block for Uplink Transmission in 5G NR System without closed-loop power control

(71) Applicant: EUCAST CO., LTD., Seongnam-si (KR)

(72) Inventor: Dong Kwan Lee, Seongnam-si (KR)

(21) Appl. No.: 18/969,258

(22) Filed: Dec. 5, 2024

(30) Foreign Application Priority Data
Dec. 12, 2023 (KR) 10-2023-0179518

(51) Int. Cl. H04W 52/24; H04W 52/26; H04W 52/36

(52) U.S. Cl. CPC H04W 52/241; H04W 52/262; H04W 52/365

(57) ABSTRACT

The present disclosure relates to a method of a 5G NR system for selecting uplink MCSs and allocating resource blocks. Disclosed is a base station of a 5G NR system, including: at least one processor, and the at least one processor may be configured to determine whether power headroom information is received from a UE, calculate, when the power headroom information is received, a virtual SINR based on the power headroom information, the virtual SINR being an expected SINR when the UE transmits one resource block, select a maximum allowed quantity of resource blocks, calculate a first adjusted SINR based on the maximum allowed quantity of resource blocks, determine, based on a target SINR set per MCS, whether there are MCSs allowing the first adjusted SINR to be equal to or greater than the target SINR, select, when there are MCSs allowing the first adjusted SINR to be equal to or greater than the target SINR, a greatest MCS MCS1 along the MCSs and determine that the UE uses the selected MCS1 and RB1 combination for uplink data transmission.

### CROSS REFERENCE TO RELATED APPLICATION

The present application claims priority to Korea Patent Application No. 10-2023-0179518, filed Dec. 12, 2023, the entire contents of which is incorporated herein for all purposes by this reference.

### FIELD

The present disclosure relates to a method for selecting an uplink MCS and allocating resource blocks in a 5G NR system.

### BACKGROUND

In a mobile communication system, in an environment where lots of UEs (user equipments) access a base station, power that each UE uses for transmitting data must be precisely controlled so that uplink data transmission from a UE to a base station can obtain the maximum efficiency.

In particular, an OFDMA (orthogonal frequency division multiple access) mobile communication system uses a closed-loop power control, in which the base station receives power of a signal transmitted by each UE, determines power to be used by each UE, and transmits the determined power to each UE through a power control message so as to optimize uplink data transmission.

In case of using the closed-loop power control, the base station receives signals of all the UEs, determines a strength of a signal, generates a power control message, and transmits the message to each UE, and therefore, there are problems that the base station must use a considerable amount of resources, and efficiency and performance of the base station may be reduced due to use of radio resources for transmitting the power control messages.

### SUMMARY

The embodiments of the present disclosure propose a method for determining the MCS (modulation and coding scheme) efficiently and allocating radio resources without using the power control message in an OFDMA mobile communication system.

One embodiment in a base station of a 5G NR system, including at least one processor. Further, the at least one processor may be configured to determine whether power headroom information is received from a UE (user equipment), calculate, when the power headroom information is received, a virtual SINR (signal-to-interference and noise ratio) based on the power headroom information, the virtual SINR being an expected SINR when the UE transmits one resource block, select a maximum allowed quantity of resource blocks RB1, calculate a first adjusted SINR based on the maximum allowed quantity of resource blocks RB1, determine, based on a target SINR set per MCS (modulation and coding scheme), whether there are MCSs allowing the first adjusted SINR to be equal to or greater than the target SINR, select, when there are MCSs allowing the first adjusted SINR to be equal to or greater than the target SINR, a greatest MCS MCS1 among the MCSs and determine that the UE uses the selected MCS1 and RB1 combination for uplink data transmission.

The at least one processor may be further configured to calculate a first expected headroom based on the maximum allowed quantity of resource blocks RB1, calculate an expected SINR by adding the first expected headroom to the virtual SINR when the first expected headroom is smaller than 0, determine the virtual SINR as the expected SINR when the first expected headroom is equal to or greater than 0 and calculate the first adjusted SINR by adding an adjustment value according to a SINR measurement history and an adjustment value according to a packet error rate (PER) history to the expected SINR.

The at least one processor may be further configured to determine a first data amount transmittable through the selected MCS1 and RB1 combination, determine, when the first data amount is smaller than or equal to an amount of requested data that the UE requests to transmit, that the UE uses the selected MCS1 and RB1 combination for uplink data transmission and determine a minimum quantity of resource blocks RB2 which makes a second data amount transmittable through a MCS1 and RB2 combination be equal to or greater than the amount of requested data and determine that the UE uses the MCS1 and RB2 combination for uplink data transmission, when the first data amount is greater than the amount of requested data.

The at least one processor may be further configured to calculate a second adjusted SINR based on the quantity of resource blocks RB2, select, when there are MCSs allowing the second adjusted SINR to be equal to or greater than the target SINR, a greatest MCS MCS2 among the MCSs, determine a third data amount transmittable through the selected MCS2 and RB2 combination, determine, when the third data amount is smaller than or equal to the amount of requested data, that the UE uses the selected MCS2 and RB2 combination for uplink data transmission and determine a minimum quantity of resource blocks RB3 which makes a fourth data amount transmittable through a MCS2 and RB3 combination be equal to or greater than the amount of requested data and determine that the UE uses the MCS2 and RB3 combination for uplink data transmission, when the third data amount is greater than the amount of requested data.

The at least one processor may be further configured to select a minimum MCS MCSmin when there are no MCSs allowing the first adjusted SINR to be equal to or greater than the target SINR, recalculate a third adjusted SINR by reducing a quantity of resource blocks, and determine whether there is a quantity of resource blocks allowing the third adjusted SINR to be equal to or greater than the target SINR of the minimum MCS MCSmin and determine, when there are quantities of resource blocks allowing the third adjusted SINR to be equal to or greater than the target SINR of the minimum MCS MCSmin, the maximum quantity of resource block among the quantities of resource blocks RB4 and determine that the UE uses MCSmin and RB4 combination for uplink data transmission.

The at least one processor may be further configured to determine a fifth data amount transmittable through the MCSmin and RB4 combination, determine, when the fifth data amount is smaller than or equal to the amount of requested data, that the UE uses the MCSmin and RB4 combination for uplink data transmission and determine a minimum quantity of resource blocks RB5 which makes a sixth data amount transmittable through a MCSmin and RB5 combination be equal to or greater than the amount of requested data and determine that the UE uses the MCSmin and RB5 combination for uplink data transmission, when the fifth data amount is greater than the amount of requested data.

The at least one processor may be further configured to calculate a third adjusted SINR based on the quantity of resource blocks RB5, select, when there are MCSs allowing the third adjusted SINR to be equal to or greater than the target SINR, a greatest MCS MCS3 among the MCSs, determine a seventh data amount transmittable through the selected MCS3 and RB5 combination, determine, when the seventh data amount is smaller than or equal to the amount of requested data, that the UE uses the selected MCS3 and RB5 combination for uplink data transmission and determine a minimum quantity of resource blocks RB6 which makes an eighth data amount transmittable through a MCS3 and RB6 combination be equal to or greater than the amount of requested data and determine that the UE uses the MCS3 and RB6 combination for uplink data transmission, when the seventh data amount is greater than the amount of requested data.

The at least one processor may be further configured to select, when there is no quantity of resource blocks allowing the third adjusted SINR to be equal to or greater than a target SINR of the minimum MCS MCSmin, a predetermined quantity of resource blocks RB7, calculate a ninth data amount transmittable through a MCSmin and RB7 combination, determine, when the ninth data amount is equal to or smaller than the amount of requested data, that the UE uses the selected MCSmin and RB7 combination for uplink data transmission and determine a minimum quantity of resource blocks RB8 which makes a tenth data amount transmittable through a MCSmin and RB8 combination be equal to or greater than the amount of requested data and determine that the UE uses the MCSmin and RB8 combination for uplink data transmission, when the ninth data amount is greater than the amount of requested data.

To calculate the second adjusted SINR or the third adjusted SINR, the at least one processor may be further configured to calculate expected headroom based on a quantity of resource blocks, calculate, when the expected headroom is smaller than 0, an expected SINR by adding expected headroom to the virtual SINR, determine, when the expected headroom is equal to or greater than 0, the virtual SINR as an expected SINR and calculate the second adjusted SINR or the third adjusted SINR by adding an adjustment value according to a SINR measurement history and an adjustment value according to a packet error rate (PER) history to the expected SINR.

The at least one processor may be further configured to, when there is no power headroom information received from the UE, select a default MCS MCSd and a default quantity of resource blocks RBd and determine that the UE uses a selected MCSd and RBd combination for uplink data transmission.

Another embodiment is a method of a 5G NR system for allocating MCSs (modulation and coding scheme) and resource blocks, including: determining whether power headroom information is received from a UE (user equipment), calculating, when the power headroom information is received, a virtual SINR (signal-to-interference and noise ratio) based on the power headroom information, the virtual SINR being an expected SINR when the UE transmits one resource block, selecting a maximum allowed quantity of resource blocks RB1, calculating a first adjusted SINR based on the maximum allowed quantity of resource blocks RB1, determining, based on a target SINR set per MCS (modulation and coding scheme), whether there are MCSs allowing the first adjusted SINR to be equal to or greater than the target SINR, selecting, when there are MCSs allowing the first adjusted SINR to be equal to or greater than the target SINR, a greatest MCS MCS1 among the MCSs, determining a first data amount transmittable through the selected MCS1 and RB1 combination, determining, when the first data amount is smaller than or equal to an amount of requested data that the UE requests to transmit, that the UE uses the selected MCS1 and RB1 combination for uplink data transmission, determining a minimum quantity of resource blocks RB2 which makes a second data amount transmittable through MCS1 and RB1 combination be equal to or greater than the amount of requested data and determining that the UE uses the MCS1 and RB2 combination for uplink data transmission, when the first data amount is greater than the amount of requested data.

Here, the calculating a first adjusted SINR may comprise calculating a first expected headroom based on the maximum allowed quantity of resource blocks RB1, calculating an expected SINR by adding the first expected headroom to the virtual SINR when the first expected headroom is smaller than 0, determining the virtual SINR as the expected SINR when the first expected headroom is equal to or greater than 0 and calculating the first adjusted SINR by adding an adjustment value according to a SINR measurement history and an adjustment value according to a packet error rate (PER) history to the expected SINR.

Embodiments of the present disclosure is capable of selecting MCS and allocating radio resources efficiently without using the closed loop power control, thereby optimizing uplink performance and realizing stable system operation.

### BRIEF DESCRIPTION OF THE DRAWINGS

FIG. 1 is a view illustrating a configuration of a general access system of a 5G NR system.

FIG. 2 is a view illustrating a frame structure for transmitting data in a 5G NR system.

FIG. 3 is a flowchart illustrating a method for determining a MCS and a quantity of a resource block used by a UE in a base station.

### DETAILED DESCRIPTION

Advantages and features of the present disclosure, and methods of achieving the same will become apparent with reference to the embodiments described below in detail in conjunction with the accompanying drawings. However, the present disclosure is not limited to the embodiments disclosed below, but may be implemented in various different forms. The present embodiments are intended to complete the disclosure of the present disclosure and provided to fully inform the skilled in the art to which the disclosure pertains of the scope of the disclosure. The disclosure is defined only by the scope of the claims. Like reference numerals refer to like elements throughout.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. The term “and/or” includes any and all combinations of one or more of the associated listed items.

The terms used in the present specification are merely used to describe specific embodiments and are not intended to limit the present invention. A singular expression includes a plural expression unless a description to the contrary is specifically pointed out in context. Components, steps, operations and/or elements that are referred to by terms “comprises” and/or “comprising” used in the inventive concept do not exclude presence or addition of one or more other components, steps, operations and/or elements.

Although the terms “first”, “second”, and the like are used for describing various components, these components are not confined by these terms. These terms are merely used for distinguishing one component from the other components.

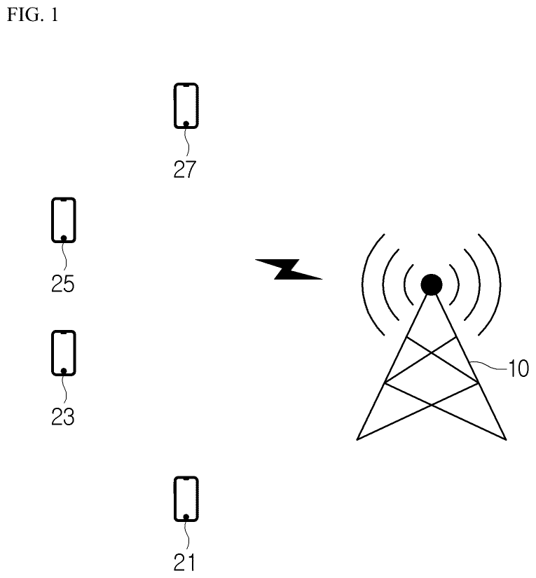

FIG. 1 is a view illustrating a configuration of a general access system of a 5G NR system.

Referring to FIG. 1, a plurality of UEs 21, 23, 25 and 27 may have accessed a base station 10 so as to perform communication in 5G NR method.

The accessed UEs 21, 23, 25 and 27 may transmit information of power available to be used by themselves for uplink (UL) data transmission to the base station 10, and the base station 10 may determine MCS (modulation and coding scheme) and resource blocks (RB) to be used by each UE for data transmission based on information of transmission power of each UE that the base station 10 has received, and notify the determined MCS and a quantity of the resource blocks to each UE. Each of the UEs 21, 23, 25 and 27 may transmit data adjusted to the MCS and a quantity of the resource blocks that they have received to the base station 10.

The base station includes at least one processor, and according to an embodiment, the processor may be a system IC specialized in performing the above-described operations or operations which will be described below. According to another embodiment, the processor may be a scheduling system specialized only in the above-described scheduling, however, according to still another embodiment, the processor May be a general universal processor, in which a program which performs operations which will be described below can be executed.

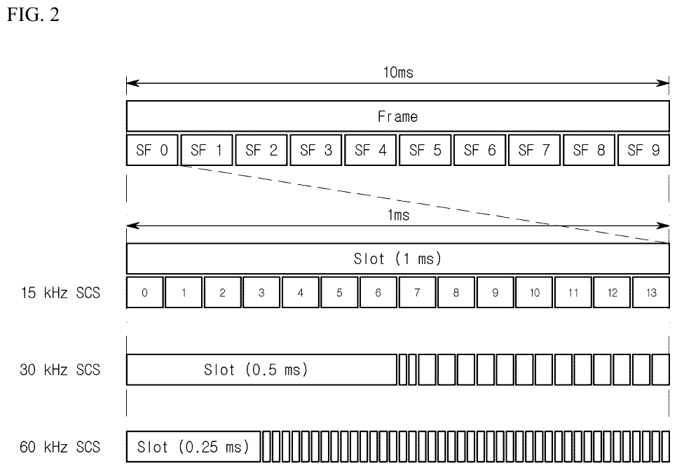

In order to transmit data and information between each UE and the base station, a frame structure illustrated in FIG. 2 below may be used.

FIG. 2 is a view illustrating a frame structure for transmitting data in a 5G NR system.

Referring to FIG. 2, one frame corresponds to 10 ms time duration, and may include 10 sub-frames SF0 to SF9.

1 sub-frame corresponds to 1 ms time duration, and may include 1 to 2 or 1 to 16 slots at maximum according to a set value of a SCS (subcarrier spacing) parameter. For example, when the SCS is set as 15 kHz, only 1 slot may exist in 1 sub-frame. When the SCS is set as 30 kHz, 2 slots may be included in 1 sub-frame. When the SCS is set as 240 kHz, 16 slots may be included in 1 sub-frame. In addition, 1 slot may include 14 OFDM symbols.

In case of a TDD (time division duplex)-based 5G NR system, each of 14 OFDM symbols inside 1 slot may be used for uplink data transmission or downlink data transmission.

Hereinafter, to simplify description, it is assumed that only 1 carrier, 1 cell, and 1 BWP (bandwidth part) are used. In case of multi carriers, a method which will be described below will be applied to the multi carriers' case in the same way, except for a part that transmission power of a UE will be distributed per carrier.

In the 5G NR system, the power to be used for the uplink data transmission by the UE in an i-th slot may be determined by the equation 1 below.

$${P}_{PUSH} ( i ) = min \{ {P}_{CMax} , 10 {log}_{10} ( {2}^{μ} \times {M}_{PUSCH} ( i ) ) + {P}_{{O}_{PUSCH}} + α \times PL + {Δ}_{TF} ( i ) + f ( i ) \} [ dBm ] \qquad [ Equation 1 ]$$

Definition of each parameter used in the equation 1 is as below.

P_{CMAX}: maximum transmittable power of the UE

μ: SCS value (0: 15 KHz, 1: 30 KHz, 2: 60 KHz, 3: 120 KHz, 4: 240 KHz)

M_{PUSCH}: a value expressing a frequency bandwidth of an allocated resource as a quantity of resource blocks RB)

P_{O}_{_{PUSCH}}: a target value (based on use of 1 resource block in 15 KHz SCS) of a UE signal strength reaching the base station. Here, the resource block is a basic unit used by the base station in the scheduling, and may be a minimum radio resource allocated to a UE. Therefore, the resource block may be used as a basic unit with respect to a size of a resource allocated to each radio resource.

PL: uplink pathloss value (dB) calculated by a UE

α: pathloss reflection ratio value

Δ_{TF}(i): adjustment value of transmission power according to a used MCS (modulation and coding scheme)

f(i): an accumulated adjustment value of uplink transmission power according to the closed-loop power control

In the above, application of Δ_{TF}(i) is optional, and whether to use it may be determined by a higher layer. In the present disclosure, description below will be provided with having a value of Δ_{TF}(i) set as 0, however, Δ_{TF}(i) may be set as an any fixed value as needed. In addition, f(i) is always 0 because the closed-loop power control is not performed.

The management parameter for uplink MCS and resource block allocation may include the following values.

System NI(noise plus interference) value: The NI value is a total amount of noise and amount of interference introduced into the uplink of the base station, and is expressed in dBm. The base station may obtain the NI value by measuring a received power in the uplink resource slot which has not been allocated. According to an embodiment, the NI value may be defined as an average amount of noise and interference received in a band corresponding to 1 resource block (based on 15 KHz SCS).

Pathloss per UE: The UE reports power headroom of the UE continuously to the base station. The headroom means a spare power from the transmission power based on a quantity of uplink resource blocks allocated to the UE. When a proper transmission power calculated based on the open loop power control is greater than the maximum available power of the UE, the power headroom becomes smaller than 0.

The base station calculates a pathloss value from the power headroom information received from the UE. In addition, based on the pathloss value, the base station calculates VirtualHeadroom, which is the expected power headroom and VirtualSinr, which is the expected SINR (signal-to-interference and noise ratio) when the base station transmits 1 resource block (based on 15 KHz SCS). It is assumed that there is no limit in the transmission power of the UE in the calculation of the virtual SINR.

The management parameter described based on the equation 1 may be calculated by the following equations 2 to 4.

$$VirtualHeadroom ( i ) = {PHR}_{report} + 10 {log}_{10} ( {2}^{μ} \times {M}_{PUSCH} ( i ) ) [ dBm ] \qquad [ Equation 2 ]$$

$$Pathloss ( i ) = ( {P}_{CMAX} - {P}_{{O}_{PUSCH}} - VirtualHeadroom ( i ) ) / α [ dB ] \qquad [ Equation 3 ]$$

$$VirtualSin r ( i ) = {P}_{{O}_{PUSCH}} - Pasthloss ( i0 \times ( 1 - α ) - NI [ dB ] \qquad [ Equation 4 ]$$

In addition, the expected headroom per UE ExpectedHeadroom(i) is a power headroom of the UE expected when a quantity of M_{PUSCH}(i) resource blocks are allocated, and may be calculated as the equation 5 below.

$$ExpectedHeadroom ( i ) = VirtualHeadroom ( i ) - 10 {log}_{10} ( {2}^{μ} \times {M}_{PuSCH} ) \qquad [ Equation 5 ]$$

Here, the expected uplink SINR ExpectedSinr(i) may be derived as the equation 6 below.

$$[ Equation 6 ]$$

$$\{ \begin{matrix}ExpectedSin r ( i ) = VirtualSin r ( n ) + ExpectedHeadroom ( i ) , & ExpectedHeadroom ( i ) < 0 \\ ExpectedSin r ( i ) = VirtualSin r ( n ) & ExpectedHeadroom ( i ) \geq 0\end{matrix}$$

A SINR adjustment value SINR_{adjust}(i) is an adjustment value according to a difference between an expected uplink SINR ExpectedSinr(i) and an actual SINR MeasuredSinr(i) reported through a physical layer, and may be calculated by the equation 7 below.

$${SINR}_{adjust} ( i ) = β \times ExpectedSin r ( r ) + ( 1 - β ) \times ( ExpectedSin r ( i ) - MeasuredSin r ( i ) ) \qquad [ Equation 7 ]$$

In the equation 7, [symbol] is a filter coefficient for averaging, and is a value used by predetermining the value, and may be set as 1/4, for example.

An adjustment value PER_adjust by a PER (packet error rate) means an adjustment value with respect to a target SINR based on a PER of a received packet. Therefore, the adjustment value PER_adjust by a PER (packet error rate) may be expressed in dB ultimately like the SINR. For example, when the target SINR with respect to a certain MCS is 5 dB and the adjustment value PER_adjust by a PER is 2 dB, the base station may perform resource allocation which enables to expect uplink SINR of 7 dB so as to use the corresponding MCS.

According to an embodiment, the base station may group the DRBs (data radio bearer) of which the same number of times of HARQ retransmission is set per UE. Next, with respect to each DRB group, the base station set a target PER according to the number of times of HARQ application and an upper limit value and a lower limit value of the adjustment value according to the PER. Such values may vary according to a channel environment, and Table 1 below is an example which only considers the maximum number of times of HARQ retransmission.

TABLE 1

| The number of | | Minimum value of | Maximum value of |
|---|---|---|---|
| times of HARQ | target PER | PER adjustment | PER adjustment |
| retransmission | (PER_{Target}) | (PER_{adjust}_{ₘᵢₙ}) | (PER_{adjust}_{ₘₐₓ}) |
| 0 | 0.3% | 0 dB | 9 dB |
| 1 | 3% | 0 dB | 6 dB |
| 2 or more | 10% | 0 dB | 6 dB |

It is possible to calculate the PER through the following process with respect to each ULSCH reception packet per DRB group.

When receiving an n-th packet, when PER_{adjust} is PER_{adjust}(n), an adjustment value by a new PER may be calculated by an equation 8 below.

$${PER}_{adjust} ( n ) = {PER}_{adjust} ( n - 1 ) + ε \qquad [ Equation 8 ]$$

In the equation 8, ε is (1−PER_{target})/K when HARQ CRC fails, and ε is −PER_{target}/K when HARQ CRC is successful. K is a constant number for reflecting adjustment according to PER on the target SINR, and K as gets bigger, the target SINR may be slowly corrected. According to an embodiment, K may be preset as one fixed value, for example, K may be set as 32.

The adjustment value by the PER PER_{adjust} may not decrease to be equal to or smaller than PER_{adjust}_{ₘᵢₙ} and may not increase to be equal to or greater than PER_{adjust}_{ₘₐₓ}.

The HARQ CRC information used in the above equation 8 may be applied only to packets of the first transmission except packets of the retransmission.

Based on the above-described parameters and adjustment values, the MCS and the quantity of resource blocks to be used for the uplink data transmission per UE may be determined.

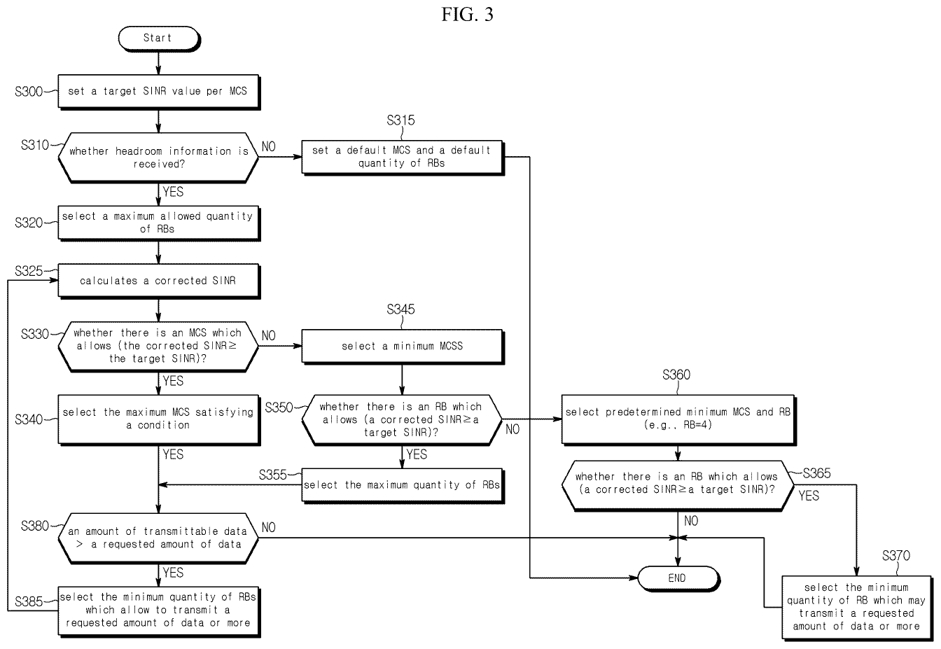

FIG. 3 is a flowchart illustrating a method for determining the MCS and a quantity of the resource block used by a UE in a base station.

In an operation S300 in FIG. 3, the 5G base station may set a target SINR value with respect to each uplink MCS. The target SINR mainly relates to a channel coding method (MCS), and may be influenced by a size of a code block. In the following description, regardless of the size of the code block, it is assumed that the target SINR(TargetSnr(MCS)) is determined only by the MCS. The target SINR may be applied the same to all the UEs, may be preset before performing the methods described in FIG. 3, and may use the set target SINR at each determination once the target SINR is set.

The basic concept of a method proposed by the present disclosure is to determine the suitability of a plurality of candidate MCS-RB combinations for a UE subjected to the scheduling, using the target SINR TargetSnr(MCS), the expected SINR ExpectedSinr, the adjustment value SINR_{adjust} according to the SINR measurement history, and the adjustment value PER_{adjust} according to the PER history, and to select a combination of the MCS and RB which has the greatest transmission amount among the candidates determined to be suitable.

Referring to FIG. 3, in an operation S310, the base station 10 may determine whether the headroom information is received from a UE subjected to the scheduling at the moment, that is, the UE for which the MCS-RB combination should be selected. Here, the headroom information may be information of power available to be used by the UE for uplink data transmission.

When the headroom information has not been received, in an operation S315, the base station 10 may allocate the default MCS and RB and end the operation. For example, the default MCS may be 5, and the quantity of RB may be 1. Here, 5 is a MCS index number, and the standard document 3GPP 36.213 may be referred for the modulation and coding method corresponding to the corresponding index number. In the description hereinafter, the MCS is expressed as the index number. The standard document 3GPP 36.213 may be referred for the modulation and coding method corresponding to the corresponding index number. In general, as the index number gets higher, the coding rate gets higher, and the amount of data transmittable by 1 resource block RB may increase.

When the headroom information has been received, the base station 10 proceeds to an operation S320, and may select a maximum quantity RB₁ of the resource blocks allowed to the corresponding UE.

Then, the base station 10 calculates an expected adjusted SINR AdjustedSinr(RB₁) with respect to the quantity of resource blocks RB₁ selected in an operation S325. Based on the equations above, the adjusted SINR AdjustedSinr(RB₁) may be calculated as the Table 2 below.

TABLE 2

```
ExpectedHeadroom(RB₁)=VirtualHeadroom−10log₁₀(2^{μ}×RB₁)
if ExpectedHeadroom(RB₁)<0
  ExpectedSinr(RB₁)=VirtualSinr+ExpectedHeadroom(RB₁)
else
  ExpecteSinr(RB₁)=VirtualSinr
AdjustedSinr(RB₁)=ExpectedSinr(RB₁)−(SINR_{adjust}+PER_{adjust})
```

The base station 10 determines, in an operation S330, whether there is an MCS which allows the adjusted SINR AdjustedSinr(RB₁) to be equal to or greater than the target SINR TargetSnr(MCS)

When there is at least one MCS which allows the adjusted SINR to be equal to or greater than the target SINR, in an operation S340, the base station may select the greatest MCS MCS₁ among the at least one MCS which allows the adjustment SINR to be equal to or greater than the target SINR. Here, the greatest MCS refers to an MCS allowing the greatest data amount transmittable using one resource block, and when referring to 3GPP standard document 36.213, it is possible to select the MCS having the greatest index number among at least one MCS which allows the adjusted SINR to be equal to or greater than the target SINR.

When there is no suitable MCS which allows the adjusted SINR to be equal to or greater than the target SINR, the base station 10 may proceed to an operation S345, and select a minimum MCS AMICO min Here, the minimum MCS may be an MCS having an index of 0 in the 3GPP standard document 36.213.

After selecting the minimum MCS in the operation S345, the base station 10 may determine whether there is a quantity of RB which allows the adjusted SINR to be equal to or greater than the target SINR in an operation S350. According to an embodiment, the base station 10 may determine whether there is a quantity of RB which allows the adjusted SINR to be equal to or greater than the target SINR in a range of a determined minimum RB (e.g., 4) or more. According to another embodiment, the base station 10 may recalculate the expected headroom ExpectedHeadroom(RB), the expected SINR ExpectedSinr(RB) and the adjusted SINR AdjustedSinr(RB) by decreasing the quantity of RB by 1, and may determine whether the recalculated adjusted SINR is equal to or greater than the target SINR of MCS having an index of 0 MCS0.

When there is a quantity of RB which allows the adjusted SINR to be equal to or greater than the target SINR, the base station 10 may proceed to an operation S355, and may select the greatest quantity of RB RB₂ among the quantities of RB which allow the adjusted SINR to be equal to or greater than the target SINR. According to an embodiment, in an operation S350, when the base station 10 determines whether the adjusted SINR is equal to or greater than the target SINR by decreasing the quantity of RB by 1, a quantity of RB satisfying the condition that the adjusted SINR is equal to or greater than the target SINR for the first time may be the quantity of RB selected in the operation S355.

In the operation S350, when the base station 10 determines that there is no quantity of RB which allows the adjusted SINR to be equal to or greater than the target SINR, the base station 10 may proceed to an operation S360, and may select a predetermined quantity of RB RB₃. According to an embodiment, it is possible to select 0 for the minimum MCS MCSmin and 4 for the quantity of RB based on the minimum data amount for the voice communication.

In an operation S365, the base station 10 may calculate the amount of data transmittable based on the selected combination of MCS and RB, that is, MCSₘᵢₙ and RB₃, and may determine whether the amount of data transmittable is greater than the requested amount of data requested by the UE according to the selected combination of MCS and RB.

When the base station 10 determines that the amount of data transmittable is greater than the requested amount of data in the operation S365, the base station 10 may proceed to an operation S370, determine the minimum quantity of RB RB₄ which may transmit the requested amount of data or more, reduce the quantity of used RB additionally, and may finally determine the combination of MCS and RB to be used by the UE as a combination MCSₘᵢₙRB₄.

As a result of determination in the operation S365, when the amount of data transmittable according to the selected combination of MCS and RB is smaller than the requested amount of data requested by the UE, the base station 10 may determine the finally selected combination of MCSₘᵢₙRB₃ as the combination of MCS and RB to be used by the UE for data transmission. Here, the RB may indicate a quantity of RBs.

After the base station 10 selects the greatest MCS MCS₁ in the operation S340, or selects the greatest quantity of resource blocks RB₂ in the operation S355, the base station 10 may proceed to an operation S380, calculate an amount of data transmittable based on the selected MCS and RB combination, that is, a combination MCS₁ and RB₁ or a combination MCSₘᵢₙ and RB₂, and determine whether the amount of data transmittable according to the selected combination of MCS and RB is greater than the requested amount of data requested by the UE.

When determined in the operation S380 that the amount of transmittable data is equal to or smaller than the requested amount of data, the base station 10 may determine the finally selected combination of MCS₁ and RB₁, or the combination of MCSₘᵢₙ and RB₂ as the combination of MCS and RB that the UE uses in the data transmission. Here, the RB may indicate a quantity of RBs.

When determined in the operation S380 that the amount of transmittable data is greater than the requested amount of data, the base station 10 may proceed to an operation S385, determine the minimum number of RB RB₅, which allows to transmit the amount of data that is equal to or greater than the requested amount of data, and decrease a quantity of RBs to be used by the UE for the data transmission additionally.

After the base station 10 changes the quantity of RBs in the operation S385, the base station 10 may proceed to the operation S325 for figuring out whether the MCS can be adjusted additionally.

In the operation S325, the base station 10 may calculate the adjusted SINR based on the quantity of RBs RB₅ determined in the operation S385. The quantity of RBs determined in the operation S385 has already satisfied the condition that the adjusted SINR is equal to or greater than the target SINR in the operation S330 or S350, and the base station may proceed directly to the operation S340, without determination in the operation S330, or even if a determination is made in the operation S330.

In the operation S340, the base station 10 may select the greatest MCS MCS₂ satisfying the condition. In addition, the base station 10 proceeds to the operation S380 and rechecks the determination, and when it is impossible to reduce the quantity of RBs more, the base station 10 finally determines the combination of MCS and RB which has been determined before in the operation S380 as it is, or may determine the RB again in the operation S385. The base station 10 may find out and determine the optimized final combination of MCS and RB by changing MCS and the quantity of RB alternately.

The Table 3 below organized operations executed in correspondence with each event which occur in the base station so as to determine the combination of MCS and RB in the 5G base station.

TABLE 3

| | |
|---|---|
| (from the physical layer) | Update a system NI value |
| receive a NI | |
| measurement report | |
| generate context | Set values of P_{CMAX}, |
| according to a UE access | P_{O}_{_{PUSCH}}, and α |
| (from the UE) receive a | calculate VirtualHeadroom, |
| power headroom report | Pathloss, VirtualSinr |
| (from the physical layer) | Calculate PER_{adjust} |
| receive a UL CRC state | |
| (from the physical layer) | Calculate SINR_{adjust} |
| receive PUSCH SINR | |
| measurement | |
| (from the MAC layer) | Select the MCS and RB |
| receive a scheduling | combination based on |
| request | VirtualHeadroom, VirtualSinr, |
| | TargetSnr(MCS), PER_{adjust}, |
| | and SINR_{adjust} |

By performing the operations above, the base station may obtain parameter values needed for determining the combination of MCS and RB with respect to the corresponding UE, when there is a request of scheduling with respect to the UE.

Using the operations described in FIG. 3, the base station 10 or a scheduling device provided in the base station 10 may determine the MCS and the quantity of RB that the UE uses for the uplink data transmission.

Although preferred embodiments of the present invention have been disclosed for illustrative purposes, those skilled in the art will appreciate that diverse variations and modifications are possible through addition, alteration, deletion, etc. of elements, without departing from the spirit and scope of the invention, and all variations or modifications are intended to be included in the scope of the present invention.

What is claimed is:

1. A base station of a 5G NR system, comprising:
at least one processor,
wherein the at least one processor is configured to:
determine whether power headroom information is received from a UE (user equipment);
calculate, when the power headroom information is received, a virtual SINR (signal-to-interference and noise ratio) based on the power headroom information, the virtual SINR being an expected SINR when the UE transmits one resource block;
select a maximum allowed quantity of resource blocks RB1;
calculate a first adjusted SINR based on the maximum allowed quantity of resource blocks RB1;
determine, based on a target SINR set per MCS (modulation and coding scheme), whether there are MCSs allowing the first adjusted SINR to be equal to or greater than the target SINR;
select, when there are MCSs allowing the first adjusted SINR to be equal to or greater than the target SINR, a greatest MCS MCS1 among the MCSs; and
determine that the UE uses the selected MCS1 and RB1 combination for uplink data transmission, and
wherein the at least one processor is further configured to:
calculate a first expected headroom based on the maximum allowed quantity of resource blocks RB1;
calculate an expected SINR by adding the first expected headroom to the virtual SINR when the first expected headroom is smaller than 0;
determine the virtual SINR as the expected SINR when the first expected headroom is equal to or greater than 0; and
calculate the first adjusted SINR by adding an adjustment value according to a SINR measurement history and an adjustment value according to a packet error rate (PER) history to the expected SINR.

2. The base station of claim 1,
wherein the at least one processor is further configured to:
determine a first data amount transmittable through the selected MCS1 and RB1 combination;
determine, when the first data amount is smaller than or equal to an amount of requested data that the UE requests to transmit, that the UE uses the selected MCS1 and RB1 combination for uplink data transmission; and
determine a minimum quantity of resource blocks RB2 which makes a second data amount transmittable through a MCS1 and RB2 combination be equal to or greater than the amount of requested data and determine that the UE uses the MCS1 and RB2 combination for uplink data transmission, when the first data amount is greater than the amount of requested data.

3. The base station of claim 2,
wherein the at least one processor is further configured to:
calculate a second adjusted SINR based on the quantity of resource blocks RB2;
select, when there are MCSs allowing the second adjusted SINR to be equal to or greater than the target SINR, a greatest MCS MCS2 among the MCSs;
determine a third data amount transmittable through the selected MCS2 and RB2 combination;
determine, when the third data amount is smaller than or equal to the amount of requested data, that the UE uses the selected MCS2 and RB2 combination for uplink data transmission; and
determine a minimum quantity of resource blocks RB3 which makes a fourth data amount transmittable through a MCS2 and RB3 combination be equal to or greater than the amount of requested data and determine that the UE uses the MCS2 and RB3 combination for uplink data transmission, when the third data amount is greater than the amount of requested data.

4. The base station of claim 3,
wherein the at least one processor is further configured to:
select a minimum MCS MCSmin when there are no MCSs allowing the first adjusted SINR to be equal to or greater than the target SINR;
recalculate a third adjusted SINR by reducing a quantity of resource blocks, and determine whether there is a quantity of resource blocks allowing the third adjusted SINR to be equal to or greater than the target SINR of the minimum MCS MCSmin; and
determine, when there are quantities of resource blocks allowing the third adjusted SINR to be equal to or greater than the target SINR of the minimum MCS MCSmin, the maximum quantity of resource block among the quantities of resource blocks RB4 and determine that the UE uses MCSmin and RB4 combination for uplink data transmission.

5. The base station of claim 4,
wherein the at least one processor is further configured to:
determine a fifth data amount transmittable through the MCSmin and RB4 combination;
determine, when the fifth data amount is smaller than or equal to the amount of requested data, that the UE uses the MCSmin and RB4 combination for uplink data transmission; and
determine a minimum quantity of resource blocks RB5 which makes a sixth data amount transmittable through a MCSmin and RB5 combination be equal to or greater than the amount of requested data and determine that the UE uses the MCSmin and RB5 combination for uplink data transmission, when the fifth data amount is greater than the amount of requested data.

6. The base station of claim 5,
wherein the at least one processor is further configured to:
calculate a third adjusted SINR based on the quantity of resource blocks RB5;
select, when there are MCSs allowing the third adjusted SINR to be equal to or greater than the target SINR, a greatest MCS MCS3 among the MCSs;
determine a seventh data amount transmittable through the selected MCS3 and RB5 combination;
determine, when the seventh data amount is smaller than or equal to the amount of requested data, that the UE uses the selected MCS3 and RB5 combination for uplink data transmission; and
determine a minimum quantity of resource blocks RB6 which makes an eighth data amount transmittable through a MCS3 and RB6 combination be equal to or greater than the amount of requested data and determine that the UE uses the MCS3 and RB6combination for uplink data transmission, when the seventh data amount is greater than the amount of requested data.

7. The base station of claim 4,
wherein the at least one processor is further configured to:
select, when there is no quantity of resource blocks allowing the third adjusted SINR to be equal to or greater than a target SINR of the minimum MCS MCSmin, a predetermined quantity of resource blocks RB7;
calculate a ninth data amount transmittable through a MCSmin and RB7 combination;
determine, when the ninth data amount is equal to or smaller than the amount of requested data, that the UE uses the selected MCSmin and RB7 combination for uplink data transmission; and
determine a minimum quantity of resource blocks RB8 which makes a tenth data amount transmittable through a MCSmin and RB8 combination be equal to or greater than the amount of requested data and determine that the UE uses the MCSmin and RB8 combination for uplink data transmission, when the ninth data amount is greater than the amount of requested data.

8. The base station of claim 3,
wherein, to calculate the second adjusted SINR, the at least one processor is further configured to:
calculate expected headroom based on a quantity of resource blocks;
calculate, when the expected headroom is smaller than 0, an expected SINR by adding expected headroom to the virtual SINR;
determine, when the expected headroom is equal to or greater than 0, the virtual SINR as an expected SINR; and
calculate the second adjusted SINR by adding an adjustment value according to a SINR measurement history and an adjustment value according to a packet error rate (PER) history to the expected SINR.

9. The base station of claim 4,
wherein, to calculate the second adjusted SINR or the third adjusted SINR, the at least one processor is further configured to:
calculate expected headroom based on a quantity of resource blocks;
calculate, when the expected headroom is smaller than 0, an expected SINR by adding expected headroom to the virtual SINR;
determine, when the expected headroom is equal to or greater than 0, the virtual SINR as an expected SINR; and
calculate the second adjusted SINR or the third adjusted SINR by adding an adjustment value according to a SINR measurement history and an adjustment value according to a packet error rate (PER) history to the expected SINR.

10. The base station of claim 5,
wherein, to calculate the second adjusted SINR or the third adjusted SINR, the at least one processor is further configured to:
calculate expected headroom based on a quantity of resource blocks;
calculate, when the expected headroom is smaller than 0, an expected SINR by adding expected headroom to the virtual SINR;
determine, when the expected headroom is equal to or greater than 0, the virtual SINR as an expected SINR; and
calculate the second adjusted SINR or the third adjusted SINR by adding an adjustment value according to a SINR measurement history and an adjustment value according to a packet error rate (PER) history to the expected SINR.

11. The base station of claim 6,
wherein, to calculate the second adjusted SINR or the third adjusted SINR, the at least one processor is further configured to:
calculate expected headroom based on a quantity of resource blocks;
calculate, when the expected headroom is smaller than 0, an expected SINR by adding expected headroom to the virtual SINR;
determine, when the expected headroom is equal to or greater than 0, the virtual SINR as an expected SINR; and
calculate the second adjusted SINR or the third adjusted SINR by adding an adjustment value according to a SINR measurement history and an adjustment value according to a packet error rate (PER) history to the expected SINR.

12. The base station of claim 7,
wherein, to calculate the second adjusted SINR or the third adjusted SINR, the at least one processor is further configured to:
calculate expected headroom based on a quantity of resource blocks;
calculate, when the expected headroom is smaller than 0, an expected SINR by adding expected headroom to the virtual SINR;
determine, when the expected headroom is equal to or greater than 0, the virtual SINR as an expected SINR; and
calculate the second adjusted SINR or the third adjusted SINR by adding an adjustment value according to a SINR measurement history and an adjustment value according to a packet error rate (PER) history to the expected SINR.

13. The base station of claim 1,
wherein the at least one processor is further configured to, when there is no power headroom information received from the UE,
select a default MCS MCSd and a default quantity of resource blocks RBd; and
determine that the UE uses a selected MCSd and RBd combination for uplink data transmission.

14. A method of a 5G NR system for allocating MCS (modulation and coding scheme) and resource blocks, comprising:
determining whether power headroom information is received from a UE (user equipment);
calculating, when the power headroom information is received, a virtual SINR (signal-to-interference and noise ratio) based on the power headroom information, the virtual SINR being an expected SINR when the UE transmits one resource block;
selecting a maximum allowed quantity of resource blocks RB1;
calculating a first adjusted SINR based on the maximum allowed quantity of resource blocks RB1;
determining, based on a target SINR set per MCS (modulation and coding scheme), whether there are MCSs allowing the first adjusted SINR to be equal to or greater than the target SINR;
selecting, when there are MCSs allowing the first adjusted SINR to be equal to or greater than the target SINR, a greatest MCS MCS1 among the MCSs;
determining a first data amount transmittable through the selected MCS1 and RB1 combination;
determining, when the first data amount is smaller than or equal to an amount of requested data that the UE requests to transmit, that the UE uses the selected MCS1 and RB1 combination for uplink data transmission;
determining a minimum quantity of resource blocks RB2 which makes a second data amount transmittable through MCS1 and RB1 combination be equal to or greater than the amount of requested data and determining that the UE uses the MCS1 and RB2 combination for uplink data transmission, when the first data amount is greater than the amount of requested data,
wherein the calculating a first adjusted SINR comprises:
calculating a first expected headroom based on the maximum allowed quantity of resource blocks RB1;
calculating an expected SINR by adding the first expected headroom to the virtual SINR when the first expected headroom is smaller than 0;
determining the virtual SINR as the expected SINR when the first expected headroom is equal to or greater than 0; and
calculating the first adjusted SINR by adding an adjustment value according to a SINR measurement history and an adjustment value according to a packet error rate (PER) history to the expected SINR.
